(19) United States
(12) Patent Application Publication
(10) Pub. No.: US 2013/0010567 A1
(43) Pub. Date: Jan. 10, 2013

(54) AGITATOR OF A LIQUID SAMPLE

(75) Inventors: Jean-Pierre Nikolovski, Chatenay Malabry (FR); Cyril Delattre, Izeaux (FR)

(73) Assignee: Commissariat a l'energie atomique et aux energies alternatives, Paris (FR)

(21) Appl. No.: 13/634,027

(22) PCT Filed: Mar. 18, 2011
(86) PCT No.: PCT/EP2011/054148

§ 371 Date: Sep. 11, 2012

(30) Foreign Application Priority Data
Mar. 19, 2010 (FR) 10 52000

(51) Int. Cl. B01F 11/00

(52) U.S. Cl. 366/110

(57) ABSTRACT

An agitator by vibrations includes an annular resonator to which is applied a vibratory stress by piezoelectric transducers. A preferred stress shape is a bending of the ring perpendicularly to its plane to excite inherent modes at relatively low frequencies. Use of a solid annular transmitter enables the vibrations to be satisfactorily controlled to maintain satisfactory transmission to the sample to be agitated, and to focus them on it. Excitation frequencies are frequencies inherent to the ring or to the tank.

The subject of the invention is an agitator of a liquid sample, which can be used to homogenise a solution by dispersing particles in it, heating the liquid, creating a nebulisation or imparting to the fluid energy sufficient to accomplish certain mechanical actions, such as the destruction (lysis) of such particles. Particles are taken to mean biological particles such as cells, bacteria, or again other particles, such as functionalised metal nanoshells.

A traditional method consists in subjecting the sample to ultrasound. This has a number of disadvantages, one of which is associated with the difficulty of transmitting sufficient energy to the sample. The sample is, indeed, enclosed in a tank, which may be a fine capillary, which is placed in the ultrasound tank filled with acoustic transmission liquid. Almost the entire energy in is lost due to the difficulty in establishing acoustic waves (pressure waves traversing the transmission liquid) with characteristics allowing satisfactory transmission of the energy to the liquid in the tank, notably limiting losses at the interfaces (the inner face and the outer face of the tank). Another disadvantage, which adds to the previous one, is that the energy which is nonetheless transmitted to the liquid in the tank does not necessarily produce the sought effect, i.e. heating, blending, dispersion, nebulisation, lysis or again rotation or centrifugation. Substantial energy must therefore be expended during a considerable period to accomplish satisfactory agitation. Blind application of mechanical vibrations, by positioning the tank on a vibrating membrane, for example, would have the same effects.

In addition, the current ultrasound blenders do not enable the agitation to be concentrated on a localised part of the sample. Focusing is taken to mean concentration of the vibrations stresses on a spatially restricted area.

Document FR-A-2 879 885 of the same inventor concerns a plate resonator which can be subjected to different modes of vibration by peripheral transducers, but which is envisaged above all as a microphone plate to transmit a vibration to the ambient air. The plate is made thinner in its centre, but is continuous, and it does not bear a load nor, above all, a tank. The bending modes which it is possible to impose on the plate are not themselves able to agitate an adjacent liquid sample.

The principal aim of the invention is to propose an agitator of liquid samples of satisfactory efficiency, i.e. which effectively transmits to the liquid in the tank a substantial proportion of the expended energy, and in such a way to enable genuine agitation of the sample, giving rise in it to appropriate movements or pressure variations.

In a general form the invention concerns an agitator of a liquid sample, including a tank containing the sample and a vibration generator, where the vibrations are communicated to the tank by an intermediate medium, characterised in that the intermediate medium is a solid ring resonator surrounding the tank and combined with the tank, and where the tank is attached to the centre of the ring and the vibration generator consists of at least one piezoelectric transducer installed in a peripheral region of the ring and constructed to transmit vibrations in the radial direction of the ring to the ring and to the tank.

Use is therefore made of vibrations in a solid communication medium to accomplish the agitation. The superiority of the invention lies in the fact that the vibrations are a mechanical displacement of large amplitude, which can exceed ten microns at 20 kHz, in a radial direction of the ring, i.e. parallel to its main plane. Such vibrations are particularly fit for producing the sought agitation. The transmission of such vibratory waves by the interfaces between the ring and the sample for agitation may be optimised to a high efficiency, such that the energy lost is relatively insubstantial. It is easy to optimise the installation to cause the ideal vibrations, notably by adjusting resonance frequencies over a preferential range between kHz and 70 kHz, and by exciting at these frequencies. Lastly, the use of a ring surrounding the tank concentrates or focuses the vibrations on the latter.

Main plane is taken to mean a plane perpendicular to the ring's axis of symmetry.

The tank will often be a tube with an axis which is roughly parallel with the ring's axis of symmetry perpendicular to the ring, and a part of which, for example the central part, will be surrounded by the ring. It will be seen that this arrangement enables a substantial agitation to be created, notably by a bending of the ring, leading to a bending of the tube, and notably of the part of the tube surrounded by the ring. This agitation can be extended throughout the content of the tube, although the vibratory waves arrive only in a small part of the tank and of the sample. These characteristics are obtained, for example, if the tube has opposite ends attached to a fixed frame belonging to the agitator.

Roughly parallel is taken to mean parallel to within ten degrees.

The resonator may be attached to the frame, notably, according to preferred possibilities, suspended from the latter by an elastic structure, or only suspended from the tube and independent of the frame.

A favourable installation consists in attaching the ends of the tube to the frame by supporting them on rubber discs (septums). It is possible to install interchangeable tubes in succession in the agitator and in the ring's central hole. Watertightness is maintained even if the ends of the tube are open. The frame may include holes revealing the rubber discs, which enables samples to be injected and then removed, using hollow needles which are sunk through the rubber discs. This arrangement allows facilitated integration in devices for treatment (preparation, analysis) of liquid samples, and notably in roaming devices, commonly designated by the term beacon.

It should be noted that the tube can either form a single piece with the ring, or be separate from it. It may be discarded after one use, which is convenient in the first case, or be washed before receiving a second sample, which may be preferred in the second case.

The agitation may be refined by creating a translation movement combined with a rotational movement of the fluid in the tube if the latter has an inner face with a helical twist, using a particular form of the vibrations.

Another improvement is accomplished if the ring tapers from the periphery to the tank, in order to concentrate the vibratory energy in a small volume of sample, and to impart to it the desired agitation firstly, before overall movements of the liquid diffuse it into the remainder of the tank.

According to another improvement the resonator includes, in addition to the ring, a central sleeve the axis of which is perpendicular to the ring in which the liquid tank is fitted. An axis perpendicular to the ring is taken to mean an axis which is roughly parallel with the ring's axis of symmetry. If the tank is tubular it can be made conical in shape in order to facilitate tightening. The sleeve lends itself to a satisfactory transmission of the vibrations to the content of the tank, and favours the application of the waves of vibration useful for agitation. In a preferred embodiment, it tapers from a place of connection to the ring until at least one end and, still more favourably, the sleeve is of generally equal thickness, either half the thickness of the ring where it is connected to the ring, or this thickness, depending on whether it transmits the vibrations to the tank by two free ends, or a single such end, and a zero thickness at the said end.

Another aspect of the invention is the choice of vibrations which are suited to agitation. It will be seen that there are several types of favourable vibration. Production of them by the ring does not pose any difficulties, due to the option of controlling them by a number of separate transducers, which are controlled separately. Be that as it may, the vibrations which it is principally envisaged to produce, and to apply to the sample, derive from a bending of the ring, i.e. the upper layers of the ring expand while the lower layers contract, and vice versa, leading to a substantial movement outside the plane of the ring at the place where the connection with the tank is made, transformed into a substantial compression movement, and therefore into a movement bending the wall of the tank at the end of the sleeve. These bending vibrations have the advantage that they have relatively low resonance frequencies, typically of the order of a few kHz to several tens of kHz, which are advantageous since they are accompanied by more ample movements. They can be obtained simply, by at least one transducer installed as a circle on the periphery of a face of the ring (upper face or lower face). Such bending vibrations can also be obtained by positioning such transducers facing one another on both faces, and controlled in opposing phases. They are transmitted efficiently to the sample and cause large-amplitude pressure waves with substantial mechanical effects.

The transducers can deliver different frequency vibrations. They can be positioned on both opposing faces of the ring to enable several simultaneous vibration controls. When the transducers follow the axial symmetry of the ring, for example fully covering the faces of the ring, the sleeve end vibrates, imparting a tank-tightening movement, which engenders a compression wave which increases as it moves inside the sample, reaching a maximum in the area of the central axis of this sample.

They can also be positioned in groups in respective sectors of arc on a peripheral region of the ring, delivering vibrations of the same frequency with phase offsets identical to angular offsets between the said circle sectors. This arrangement is used to create an overall rotating movement of the fluid due to a rotating tilting action of the sleeve which favours the blending of the fluid and, possibly, the diffusion of another effect of the vibrations throughout the entire sample.

One particularly appreciated embodiment includes firstly a complete circular transducer on one face of the ring to create an asymmetric vibration mode, in the form of a bending with axial symmetry, producing the compression waves in the sample, producing mechanical effects in it involving a first type of agitation; secondly, the group of piezoelectric transducers mentioned above on the opposite face of the ring to create a non-axisymmetric bending mode, and to impose a circular movement on the fluid involving a second type of agitation.

A magnet may be adjacent to the tube and to the ring in certain applications, for example to attach magnetic particles, for example metal nanoshells. The magnet then concentrates them in proximity to the ring, where they are subjected to the vibratory energy.

Several embodiments of the invention will now be described in detail in order to develop its various characteristic aspects, and the effects obtained. Reference will be made to the following appended figures, given purely as illustrations:

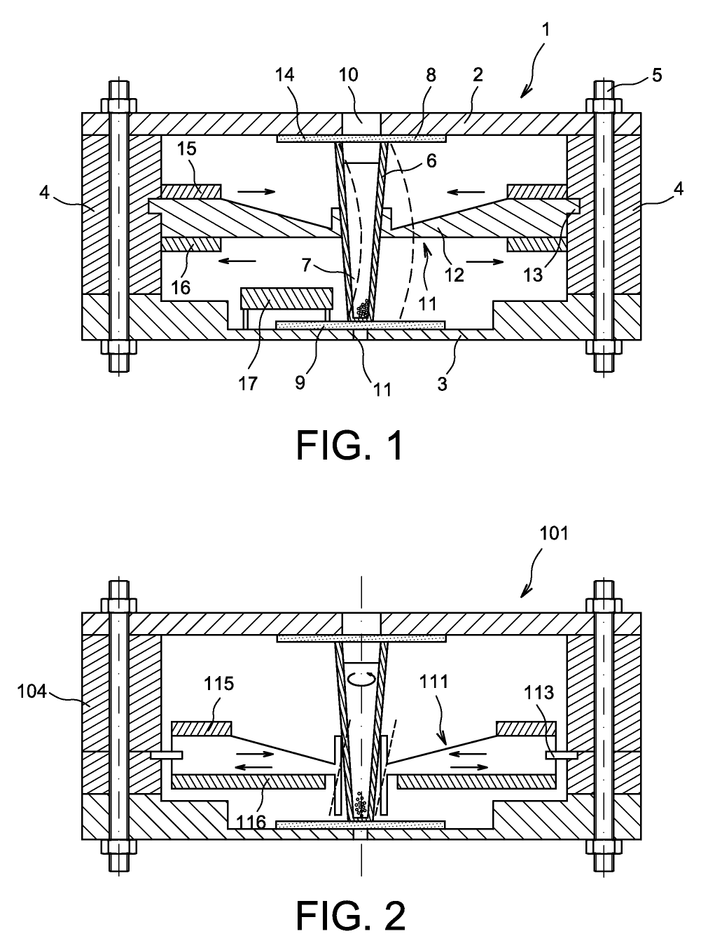

FIGS. 1, 2, 3, 4, 5 illustrate respectively five particular embodiments of the invention,

and FIGS. 6, 7, 8, 9 and 10 give details concerning the embodiment or operational details.

A first embodiment of the invention is represented in FIG. 1. The agitator includes a frame consisting of two parallel plates 2 and 3 and a circular wall 4 inserted between plates 2 and 3. The construction is held in place by tightening screws 5 and forms a chamber. A tank having the shape of a conical tube 6 of a liquid sample 7 extends in the chamber, between plates 2 and 3, with its vertical axis in the figure. It is supported on two rubber discs (septums) 8 and 9, which are themselves supported on plates 2 and 3. Holes 10 and 11 are pierced through the plates 2 and 3, revealing the rubber discs 8 and 9. Hollow needles can traverse discs 8 and 9 to inject the sample 7 or to remove it. It is then not necessary to disassemble the agitator between the treatments of two successive samples 7. However, it would be possible to use closed tubes which would be installed one after another. A resonator 11 includes a horizontal ring 12 extending halfway between the plates 2 and 3, the periphery of which is attached to the circular wall 4 by rigid shoulders 13 which penetrate into it, and the thickness of which decreases from the periphery to the centre. The ring 12 is pierced in the centre. The resonator 11 also includes a central sleeve 14, the axis of which extends perpendicularly to the ring 12, which demarcates the piercing of the ring 12, and the tube 6 is installed in it, being fitted in this place by tightening. The axis of the central sleeve 14 is merged with the axis of the tube 6, and also with the axis of symmetry of the ring 12. The resonator 11, including the ring 12 and the central sleeve 14, has a rotational symmetry relative to an axis merged with that of the tube 6. The resonator 11 is excited by piezoelectric transducers 15 and 16 arranged as a ring on its upper face and under its lower face in the peripheral area. A magnet 17 may be added to the device for certain operations, such as a concentration of magnetic particles, which must then be dispersed in the sample 7. These may be ferroparticles used in biology to act as supports for cells.

The excitation of the transducers 15 and 16 deforms the resonator 11 and transmits vibrations to the tube 6 and to the sample 7. The mode of the vibrations is a bending of the ring 12 obtained by controlling the transducers 15 and 16 in antiphase, the transducer 15 expanding in the horizontal direction (radial of ring 12) when the opposite transducer 16 contracts. The shearing of the ring 12 due to the parallel and opposite movements of its lower and upper layers leads to bending movements in the centre, engendering a compression/expansion movement of the end of the sleeve 14, which is efficiently transmitted to the liquid sample. It has been observed that the excitation of the ring subject to bending gave relatively low resonance frequencies, which may be between several kilohertz and several tens of kilohertz, which have the advantage that they are accompanied by larger amplitudes and lesser damping: less electrical energy is therefore required to excite transducers 15 and 16. The application of vibrations in the radial direction (i.e. perpendicular to the resonator's axis of symmetry) perpendicular to the wall of the tube 6 using the sleeve 14 allows satisfactory transmission of the vibratory energy to the sample 7 through the interface constituted by the tube 6. An efficiency of 40% of energy transmitted (against 60% of energy reflected) may be attained when the tube is made from plastic, such as polypropylene. If there is no sleeve 14, the tube 6 would be subjected essentially to vertical vibrations, along its axis, which would produce only very little agitation of the sample 7, particularly since these vibrations would be almost entirely reflected at the interfaces of the tube. The energy transmission efficiency between transducers 15 and 16 and the ring 12 is also approximately 40%, if manufactured with care. The agitation produced by this energy arriving at the sample 7 is substantial since the tightening variations of the tube 6 by the sleeve modify its diameter and are transmitted to the sample 7 in the form of pressure waves creating the mechanical effects sought in the methods for destruction or fragmentation of particles, and possibly going so far as nebulisation or cavitation phenomena in the liquid, and involving substantial stirring of the sample 7, and therefore a blending of its parts. Moreover, the dissipation of the vibration energy in the area of the coupling of the sleeve 14 with the tube 6 can enable the sample 7 to be heated, or facilitate stirring due to the degassing in the liquid produced by the heating.

These effects are verified more specifically if the cavitation is obtained using quite ample movements of the tube 6. The thinning of the ring 12 towards its centre, making it more flexible in this location, increases the amplitude of the vibrations (by conservation of the quantity of movement) and concentrates the application of the energy whilst reducing the inherent frequencies.

The sleeve 14, which is required to apply a radial component element, also enables this energy to be distributed, over a sufficient volume of the sample 7 for its effect to be more emphatic, by avoiding too substantial a concentration. For example, it has been observed that by using a glass tube of outer diameter 2.5 mm, a coupling surface (surface of the sleeve in contact with the tube) of at least 3 mm² allowed satisfactory agitation of a sample volume of several tens of mm³.

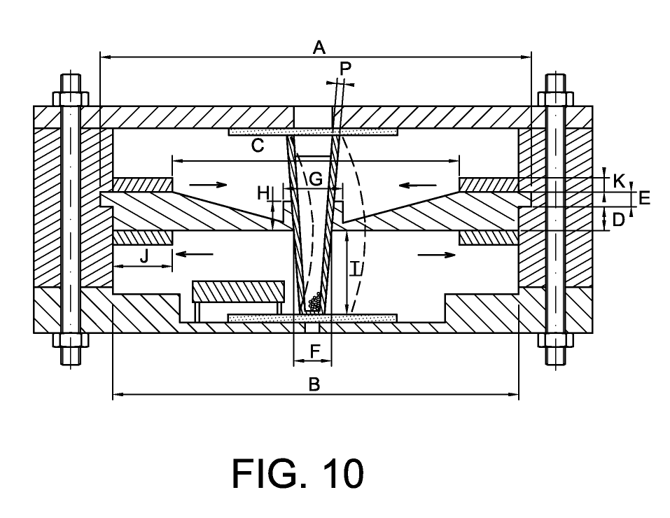

The resonator 11 may be made from aluminium or glass, notably thermally moulded or plastic (polypropylene, polycarbonate, etc.), the transducers 15 and 16 may be made from ceramics, and the tube 6 from metal, glass or plastic. The transducers 15 and 16 may be made from lead zirconate titanate or other piezoelectric materials such as barium titanate, or vinylidene polyfluoride (PVDF). Table I, in correlation with FIG. 10 which again represents the embodiment of FIG. 1, gives a few possible dimensions of the equipment; but they are not critical.

TABLE I

| | | |
|---|---|---|
| A | 20 to 70 | Diameter of the |
| | | resonator with shoulder |
| B | 19 to 69 | Diameter of the |
| | | resonator without |
| | | shoulder |
| C | 5 to 20 | Diameter of the tapering |
| | | area |
| D | 1 to 7 | Thickness of the |
| | | resonator |
| E | 0.1 to 1 | Thickness of the |
| | | shoulder |
| F | 0.1 to 20 | Inner diameter of the |
| | | area of coupling with |
| | | the tank |
| G | 0.3 to 21, | (The thickness of the |
| | preferably | resonator sleeve varies |
| | 1 to 5 | between 0.1 mm and 0.5 mm) |
| H | 2 to 10 | Height of the sleeve |
| I | 0 to 10 | Height of the coupling |
| | | area with particles |
| J | 5 to 20 | Width of the transducer |
| K | 0.1 to 1 | Thickness of the |
| | | transducer |
| P | 0.2 to 1 | Thickness of the tank |

The various settings are chosen so as to obtain relatively low resonance frequencies, of a few tens of kilohertz, in order to obtain more substantial movement amplitudes, typically between 1 and 20 microns of point-to-point amplitude in the area where the sleeve is coupled to the tube, and low damping. The audible frequencies will preferably be avoided, and this is the reason why resonance frequencies higher than 20 kHz will preferably be chosen. The resonance frequencies which will be sought are those of the ring 12, or of the unit constituted by the ring and the tube. It is possible in many cases to optimise the construction in order that one of these inherent frequencies is common to the ring 12 and to the tube 6. The two opposite transducers 15 and 16 enable the ring to be bent better using stress symmetry, but a single one might suffice.

They can be controlled at a single electrical frequency, or by a signal which is the superimposition (simultaneous application of several frequencies) or the juxtaposition (successive applications of signals of different frequencies during a predetermined time interval, for example of the order of one millisecond for each frequency component element), where these frequencies are normally chosen from among the resonance frequencies. They can be so chosen at the same frequencies, or on the contrary the excitation frequencies can be distributed between the transducers 15 and 16, since opposing excitations by the transducers 15 and 16 are not necessary. The ring 12 or the unit constituted by the ring 12 and the tube 6 each have several resonance frequencies, which correspond to the same number of separate inherent modes, but excitations at the first inherent modes (simple bending of the ring, with unvarying deflection from the periphery towards the centre, and bending of the tube 6 at two vibration nodes at the ends, and a single vibration antinode, at the connection to the sleeve 14, these modes being expressed as dotted lines in FIG. 1), are normally preferred, since their frequencies are lower; but a simultaneous excitation of several inherent modes is conceivable for one or other of these two elements, or both.

Another embodiment will now be described by means of FIG. 2. These are the differences which can be noted compared to the previous embodiment. The resonator, now 111, has no shoulders for attachment to the circular wall 104, but it is suspended from it by flexible beams 113, which may be four in number, distributed in quarter circles around the circumference of the device. Since a greater disconnection is accomplished with the frame 101, the resonator 111 has fewer resonance modes, and their resonance amplitude is greater, improving the quality factor. The lower transducer 116 extends under the entire lower face of the ring 112, and can contribute alone to the establishment of the bending vibrations, while the upper transducer 115, which is unchanged relative to the previous embodiment, and therefore of smaller area and lesser power, provides additional power, for example at another frequency or at the same frequency, or again creates another type of vibration, as will be described in connection with FIGS. 6 and 8. The choice of asymmetrical transducers, of transducers which are controlled at differing frequencies, or of asymmetrical rings relative to the median plane (the inclination of one face of which differs from that of the other, which is the case in FIGS. 1 and 2, where the lower face of the ring 12 or 112 is flat), makes excitation at a pure bending mode, implying perfect symmetry of the resonator and its excitation, more difficult, but this is not necessarily detrimental. In other words, a resonator including a ring 12 having a symmetry plane, or median plane, will be preferred, since this allows the resonator's quality coefficient to be improved, and therefore the amplitude of the vibrations for a given excitation energy to be improved. It will be recalled that the quality coefficient is an indicator quantifying the sensitivity of a resonance peak.

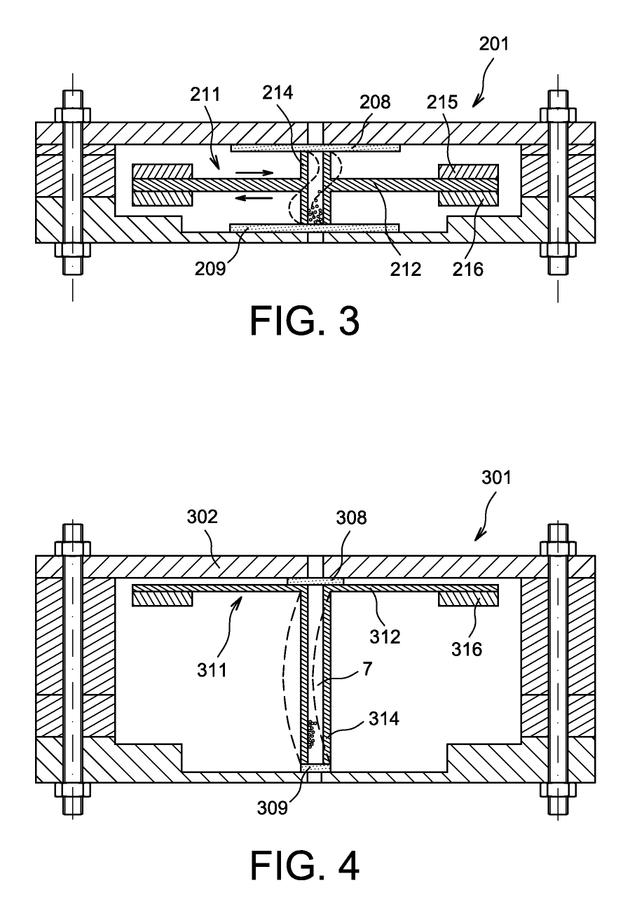

Another embodiment is described in FIG. 3. It is distinguished from the previous ones in that the tank is now incorporated in the resonator, i.e. in that the resonator 211 includes a ring 212 and a sleeve 214 extending from the centre of the previous one as far as the rubber discs 208 and 209 (similar to those of the previous embodiments). Sample 7 is therefore contained directly in the sleeve 214. Ring 212 is in this case of constant thickness, and its peripheral region is still fitted with transducers 215 and 216 on its opposite faces, the areas of which are identical. They are controlled in antiphase, and can still impose a bending on the sleeve 214, in accordance with the dotted line of FIG. 3, in which the sleeve has, however, in a first particular embodiment, a third vibration node in the area of the connection to the ring 212, and two antinodes between this node and the ends supported on the rubber discs 208 and 209, where these ends then constitute the first and second vibration nodes. The resonance frequency of the tank (sleeve 214) will therefore be, all other things being equal, different from that of tube 6 of the previous embodiments.

Another difference from the previous embodiments is that the ring 212 is separate from the frame 201 and suspended only from the sleeve 214. This lack of a connection between the ring 212 and the frame 201 is beneficial because it prevents, even better than with the embodiment of FIG. 2, any influence of the vibratory properties of the resonator 211, which therefore has better defined and more selective inherent modes (i.e. more sensitive and more spaced out one from another).

The sleeve preferably has sufficiently height for vibration nodes to appear. At design, the vibration profile of the sleeve will be observed, for example by laser vibrometry, and its height will be adapted such that both ends constitute vibration nodes. The adaptation of the height can also be accomplished by simulations.

A fourth embodiment is defined by means of FIG. 4. The sleeve 314 remains incorporated in the ring 312 of the resonator 311, and it is supported, similarly, on the rubber discs 308 and 309 enclosing the sample 7, but the ring 312 is no longer connected to it by the middle but by one end: it is therefore adjacent to one of the plates of the frame, and on the upper plate 302. Since a single transducer is sufficient to produce the desired excitation, it is possible only to use the lower transducer 316, since the ring 312 is close to the upper plate 302. It is a vibration node.

The first inherent mode of vibrations includes a single central antinode, and two nodes at the ends, as with the embodiments of FIGS. 1 and 2. The latter show that there is no requirement that the resonator be connected to the centre of the sleeve, or in general from the tank to the sample.

Compared to the first and second embodiments, the third and fourth embodiments enable a friction or a viscous damping between the sleeve and the tube to be prevented. This leads to more efficient transmission of the vibration energy to the sample results, together with less heating of the sample.

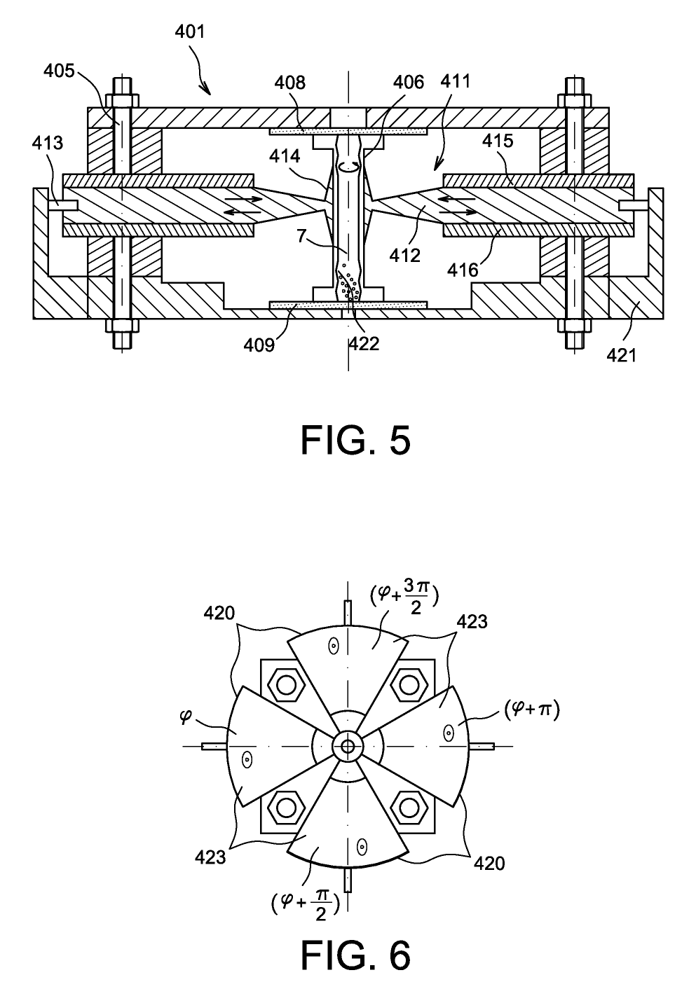

We now present a fifth embodiment of the invention, described by means of FIGS. 5 and 6. Resonator 411 includes a ring 412 divided into four sectors covering angles of approximately 70°, and each extending between a pair of tightening screws 405 of the frame 401, and then outside the latter. The sectors 420 are, for example, suspended from a mandrel 421 driving the frame 401 by flexible beams 413 comparable to those of FIG. 2. This construction is justified by the need to increase the acoustic power injected into the fluid, which can be useful in certain applications, for example when it is desired to lyse biological particles. The aim then is to increase the active surface of the transducers whilst reducing the resonance frequencies of the ring by lengthening it, while the dimensions of the frame can be imposed for other reasons, of integration or of connection to a related piece of equipment, for example. The ring 412 is pierced in the centre and connected to a central sleeve 414, as in the other embodiments; the sleeve 414 grips a tube 406 used as a tank for sample 7, the tube 406 being cylindrical, such that the sleeve 414 is supported on it over its entire inner circumference. There is a slightly tightened adjustment between the tube 406 and the sleeve 414 to provide a firm contact without preventing the replacement of tube 406. A couplant, of the polymer gel type, can be used in the gripping zone, at the interface between the sleeve 414 and the tube 406, in order to improve the transmission of the vibrations. The tube 406 can include a helical bore 422 in its inner face. It is also supported on rubber discs 408 and 409. Ring 412 is, in this case, symmetrical in relation to a plane of median thickness, and its thickness is constant over a more extensive peripheral region than in the previous embodiments; but the central region of the ring 412 also tapers towards the sleeve 414. The lower transducer and the upper transducer 415 and 416 are identical and extend over most of the surface of the ring 412, and are divided into sectors 423, as is the ring.

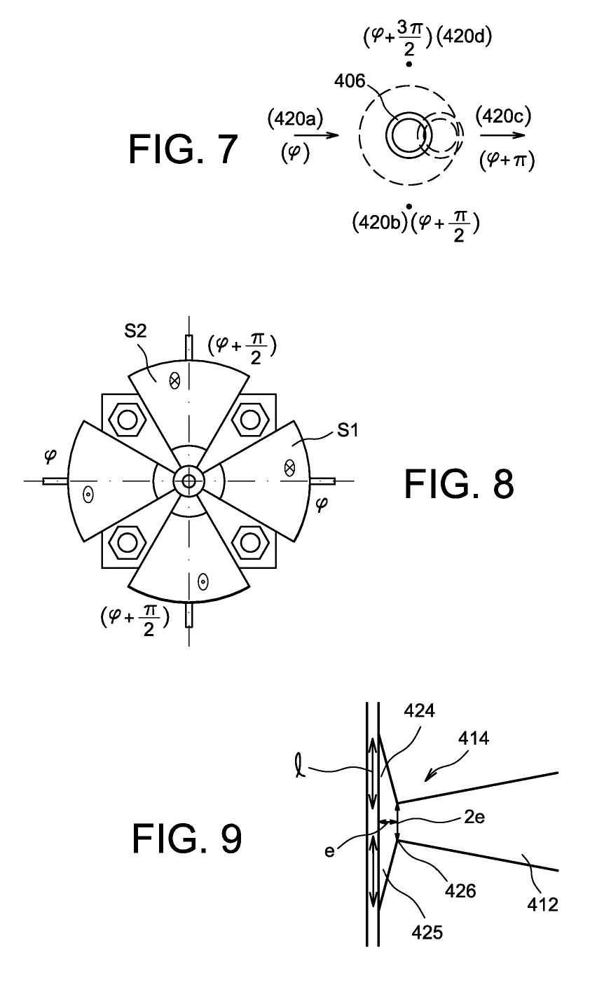

The division of the transducers is necessary in this case due to the tightening screws 405 which must be avoided, but it must be stressed that this division gives a marked advantage: it enables vibration control to be applied with a phase offset, giving rise to a rotating movement of the sample 7. FIG. 7 shows the effect obtained by controlling sectors 421a to 421d in quarter phases: when a sector 420a pushes at an instant on the tube 406, the opposite sector 420c in antiphase moves away from it, while the intermediate sectors 420b and 420d are at the neutral point. Tube 406 therefore moves at this instant to the right of FIG. 7; it is clear that by controlling sectors 420 at the same frequency, sample 7, which is present in the part of the tube 406 in contact with the sleeve 414, will adopt a circular movement indicated by the dotted arrow. It has been observed that this excitation creating a circular movement of the sample 7 present in the tube 406 was very beneficial to favour the stirring of the sample 7 and therefore obtaining a uniform blend, firstly by concentrating the deformation of the tube and the application of the pressure wave on an angular section at each instant, favouring the movement of the sample, and in particular the delamination of particles from the wall of the tube 406 at the location in question, and then by giving rise to a circular movement of the entire sample 7 favouring blending of it. The bore 422 reinforces the blending by favouring movements of the sample in the direction of the axis of the tube 406, and the liquid close to the tube 406 adopts it during its circular movement.

Such a division of the resonator or at least of the transducers into sectors in order to apply phase-shifted excitations to obtain a circular movement of the tube is so favourable that it is envisaged to adopt it in other embodiments of the invention, notably those which have been previously described. It should be stipulated that, according to this embodiment, the resonator can remain monolithic and include multiple transducers on the same face, but it is preferable that the ring should also be divided into sectors, with the sectors of the ring preferably having the same angular openings as the transducers. Moreover, the tank tube is preferentially inserted by force in the sleeve in order that the vibrations traverse it, and do not cause it to rotate instead of the sample. Since the resonator is completely without the outline of the frame it is possible for the sectors to have 90° angular extensions when there are four such sectors, and for them to be separated by thin slits. A different number of sectors and phases can then be chosen, provided they number at least three to create the circular movement. The sectors 423 of the transducers 415 and 416 can be controlled either by the same piezoelectric polarisation and four electrical phases, as was suggested in connection with FIG. 7, or by opposing polarisation directions, and only two electrical phases, as is suggested by FIG. 8, which can simplify the electrical control installation. The rotating excitation of the tank with the sample is, however, unable to exert a substantial mechanical action other than the imparting of movement and the stirring of the liquid, since the sections of the tank are not substantially deformed. It is therefore precious when a nebulisation, or a blend of sample 7, or a dispersion of particles, is sought, but it is insufficient for a fragmentation of particles, for example: the axisymmetric vibration modes will then be preferred, which produce periodic contractions of the sections of the tank, and much stronger pressure waves. It will often be advantageous to combine both excitation families, either with a given transducer divided into sectors (where all the sectors are controlled in the same phase of a frequency to create the axisymmetric part of the vibrations) by applying a control with several frequencies, or with opposing transducers since they can be controlled separately; the transducer associated with the axisymmetric vibrations can then be continuous over a complete circle.

Another aspect of the invention will now be described: the favourable dimensioning of the sleeve relative to the ring. The embodiment of FIG. 5 is particularly favourable in this way since (FIG. 9) the sleeve 414 consists of two lips 424 and 425 extending from the place of connection 426 to the ring 412 in opposite directions, and each tapering towards their free end in such a way that their thickness gradually changes from a maximum thickness “e” at the place of connection 426 to a zero thickness at the free ends. The maximum thickness “e” of the sleeve 414 is equal to half the thickness “2.e” which the ring 412 takes at the place of connection 426. The thickness “e” can be 1 mm, and the length “l” of each of the lips 424 and 425 is approximately 5 mm; these dimensions are not however critical. These dimensioning rules firstly allow the vibratory energy to be transmitted from the ring 412 to the lips 424 and 425, and then allow it to be transmitted to the tube 406, due to the flexibility of the lips 424 and 425 at their free ends, which are subject to large-scale displacements.

Similar dimensioning rules can be proposed for other embodiments. In that of FIG. 3 it is thus possible to consider that the sleeve 214 still includes two lips: the thickness of the ring 212 is then equal to twice the thickness of the sleeve 214 at the place where they are connected. In the embodiments of FIGS. 1 and 4, in which the sleeve 14 or 314 extends over a single side of the ring 12 or 312, its thickness is equal to that of the ring 12 at the place where they are connected.

It is evident that other embodiments may easily be conceived from that which has been described, including by a substitution or by a combination of elements drawn from different embodiments.

The agitator may form a part of a more complete installation for treatment of samples of liquids, such biological liquids for example. The tank may be a tube commonly used in a biology laboratory, for example a traditional tube of Eppendorf or Falcon brand.

Throughout the description it has been shown how a device according to the invention enabled particles to be dispersed in a fluid. Of course, such a device also allows multiple liquids to be blended, for example immiscible or poorly miscible liquids.

Similarly, in the description, piezoelectric transducers have been described. In certain cases the invention can use other magnetostrictive transducers. Such transducers are electromechanical or magnetomechanical transducers.

However, piezoelectric transducers, and more specifically ferroelectric ceramics, are the preferred transducers.

We will now describe an example of the use of an agitator according to the invention for lysis of biological species such as spores, bacteria and viruses.

It is known that agitation of microballs in solution can enable lysis of such biological species present in the solution when the balls are agitated. Lysis is due to abrasive effect of the balls on the biological species. Microballs means balls with a diameter of less than 1 mm, typically a few ten to a few hundred μm.

The inventors attempted to use mobile agitators in the form of propellers, to cause sufficient abrasion of spores. They were confronted with a problem of reliability of such agitators. Furthermore, the presence of mobile parts immersed in the solution is a nuisance, for example they have to be cleaned between two uses. Furthermore such parts can wear mechanically.

By using an agitation device according to this invention, microballs can be entrained without having a mobile part immersed in the medium to be agitated. This also enables integration into a beacon.

One example device is given below: the actuator is composed of an aluminium resonator in the form of a large 50 mm diameter 2.65 mm thick ring 512 defining a 2.4 mm diameter opening at its centre

On each face of the ring (lower face and upper face), 4 identical lead zirconate and titanate type ceramic transducers 520 (made by Ferroperm—reference PT 26) arranged in four adjacent sectors of concentric rings. Each transducer has a large 25 mm radius, a small 10 mm radius and is 0.5 mm thick. Each transducer 520 on a particular face of a ring 512 has a phase shift of π/4relative to the adjacent sector. With this arrangement, each transducer on one face of the ring 512 is facing a transducer on the other face of the ring, two adjacent transducers being activated in phase opposition.

Each transducer 520 is excited by an AC signal with a peak to peak RMS voltage of 50V and RMS intensity 2.5 mA, and resonance frequency 20 kHz. The consumption of the device is equal to 500 mW, which corresponds to a power per unit volume of the liquid sample to be stirred (about 50 μl) equal to 10 W/cm^{3.}

The liquid sample is dipped into a 34 mm high, 300 μm thick polypropylene tube 506 with a conical section, minimum outside diameter 2.4 mm, and maximum diameter 5 mm. 100 μm diameter zirconium dioxide (zirconia) balls are placed in the sample. Their mass is typically between 15 mg and 75 mg.

The polypropylene tube 506 is held in place by a coaxial aluminium sleeve 514. The sleeve 514 is fixed to the ring 512 and is coaxial with it. Its length is 3.8 mm. The inside surface of the sleeve 514 matches the outside surface of the tube 506. The tube 506 is held such that its bottom is 1.4 cm from the sleeve 514. Silicone grease may be placed on the outside surface of the tube at the contact with the sleeve, so as to facilitate transmission of the acoustic signal.

The liquid containing the spores may be water or a saline buffer. It may advantageously contain a lysis buffer which improves the efficiency of lysis, but this is not necessary.

Activation of transducers 520 generates a rotating bending wave, entraining microballs in the sample in a rotation movement. The microballs then cause abrasion of the spores making up the sample. The combined action of the rotating wave and rotation of microballs applies a rotation movement to the liquid sample, and a translation movement in tube 506. Consequently, most or even all of the sample is affected by abrasion by the microballs.

The spores containing the sample are Bacillus Subtilis and/or Bacillus Thurigensis type spores, and the concentration of the spores in the sample is 10⁶ spores in 20 λl.

The agitation time is 2 minutes, which is sufficient to obtain a sample containing DNA of the lysed biological species, the lysis yield of the spores being nearly 100%. Such yields can be obtained with more complex commercially available devices with moving parts, and much more expensive. This device is also easily cleanable. The yield has been determined by quantification of purified DNA by a quantitative PCR type analysis.

This device may be integrated into a polycarbonate casing enabling electrical and mechanical confinement from the outside. The dimensions of this casing are included within a volume of 5 cm*5 cm*5 cm. The result is then a robust, nomad device that can be built into a beacon and consumes small quantities of energy.

Preferably, the device comprises a first needle 551 to convey the liquid sample, this first needle opening up into tube 506, for example at its top end. The device may also comprise a second needle 552, preferably opening up at the bottom end of the tube 506, and that will be used for sucking in the liquid sample contained in the tube. The first and second needles 551 and 552 may be made of metal, for example stainless steel, and may have a 450 μm outside diameter and a 350 μm inside diameter.

Preferably, the second needle 552 is centred in the tube 506. In other words, it is aligned with the longitudinal axis of the tube 506. Thus, the balls easily turn around the needle 552. The diameter of one end of the second needle 552 is less than the diameter of the balls so that the balls cannot be sucked in.

Thus, a device according to the invention can be used for lysis of biological species to be lysed. The device comprises:
A resonator 512 with a cylindrical geometry and annular section comprising a plurality of adjacent transducers 520 on one of its plane faces, such that different transducers on a particular face are out of phase with each other;
a tube 506 in which there will be a liquid containing the species to be lysed;
the resonator 512 being fixed to the tube 506.

Preferably, the phase shift between each transducer, considered to be in the same direction of rotation, has the same sign. When considering n transducers on a same face of the resonator, n≧2, the phase shift between two adjacent transducers may be 2π/N.

Preferably, the resonator comprises a projecting sleeve 514 coaxial with the centre of the ring 512, capable of holding the tube 506 containing the sample to be lysed in position.

Preferably, the device comprises a means 551 of conveying the liquid sample into the tube in the form of a first needle with an inside diameter between 10 μm and a few 100 μm. This first needle can open up in the upper part of the tube.

The device may also comprise a means 552 for sucking in the liquid sample contained in the tube, in the form of a second needle with an end diameter less than the diameter of the balls.

The lysis process using the device according to the invention then comprises the following steps:
bring the liquid containing the biological species into tube 506 which contains balls
start movement of the balls by activating transducers 520 according to the invention, such that the balls start a rotation movement, the movement of the balls then producing lysis of said biological species
the liquid containing the lysed biological species contained in the tube is sucked in, the suction means 552 discriminating balls from the liquid and the lysed species, such that only the liquid and the lysed biological species are sucked in.

1-24. (canceled)

25. An agitator of a liquid sample, comprising:
a tank containing the sample; and
a vibration generator, wherein vibrations are communicated to the tank by an intermediate medium,
wherein the intermediate medium is a solid ring resonator surrounding the tank and combined with the tank, and
wherein the tank is attached to the center of the ring, and the vibration generator includes at least one piezoelectric transducer installed in a peripheral region of the ring and constructed to transmit vibrations in a radial direction of the ring to the ring and to the tank.

26. An agitator of a liquid sample according to claim 25, wherein the tank is a tube with an axis perpendicular to the ring.

27. An agitator of a liquid sample according to claim 26, wherein the tube has opposite ends attached to a fixed frame.

28. An agitator of a liquid sample according to claim 27, wherein the resonator is attached to the frame at a periphery of the ring.

29. An agitator of a liquid sample according to claim 27, wherein the resonator is suspended from the frame by an elastic structure.

30. An agitator of a liquid sample according to claim 27, wherein the resonator is suspended from the tube and is independent of the frame.

31. An agitator of a liquid sample according to claim 27, wherein ends of the tube are attached to the frame, and are supported on rubber discs.

32. An agitator of a liquid sample according to claim 31, wherein the frame includes holes revealing the rubber discs, and the ends of the tube are open.

33. An agitator of a liquid sample according to claim 26, wherein the tube includes an inner face with a helical bore.

34. An agitator of a liquid sample according to claim 25, wherein the ring tapers from its periphery towards the tank.

35. An agitator of a liquid sample according to claim 25, wherein the resonator includes a central sleeve of axis perpendicular to the ring, and the tank is gripped in the sleeve.

36. An agitator of a liquid sample according to claim 35, wherein the tank is a tube with an axis perpendicular to the ring and the tube is conical.

37. An agitator of a liquid sample according to claim 25, wherein the vibration generator includes multiple transducers controlled separately.

38. An agitator of a liquid sample according to claim 25, wherein the transducer delivers vibrations at different frequencies.

39. An agitator of a liquid sample according to claim 37, wherein a group of transducers extends over respective sectors of an arc of a peripheral area of the ring, and delivers vibrations of identical frequency with phase shifts identical to angular shifts between sectors of an arc.

40. An agitator of a liquid sample according to claim 37, wherein the transducers are positioned on two opposite faces of the ring.

41. An agitator of a liquid sample according to claim 40, wherein the resonator includes a central sleeve of axis perpendicular to the ring, the tank is gripped in the sleeve and the vibrations delivered by the transducers positioned on the opposite faces of the ring have component elements in antiphase, and thus produce a bending of the ring.

42. An agitator of a liquid sample according to claim 25, wherein the vibration generator includes a complete circular transducer delivering a symmetrical vibration producing an oscillating compression of the tank.

43. An agitator of a liquid sample according to claim 42, wherein a group of transducers extends over respective sectors of an arc of a peripheral area of the ring, and delivers vibrations of identical frequency with phase shifts identical to angular shifts between sectors of an arc, the transducers are positioned on two opposite faces of the ring and the agitator includes the group of transducers on one of the faces and a complete circular transducer on the opposite face.

44. An agitator of a liquid sample according to claim 35, wherein the sleeve tapers from a place of connection to the ring as far as at least one end.

45. An agitator of a liquid sample according to claim 44, wherein the sleeve has a thickness equal either to half a thickness of the ring, or to the thickness, depending on whether it has two ends, or one end, and a zero thickness at the other end.

46. An agitator of a liquid sample according to claim 34, wherein the transducers of the group are four in number, their vibrations are shifted by a quarter phase, and they extend over angular sectors of 70°.

47. An agitator of a liquid sample according to claim 26, further comprising a magnet adjacent to the tube and to the ring.

48. An agitator of a liquid sample according to claim 29, wherein the transducer is piezoelectric.
